(19) United States
(12) Patent Application Publication
(10) Pub. No.: US 2026/0360836 A1
(43) Pub. Date: Nov. 12, 2026

(54) RECHARGEABLE BATTERY AND RECHARGEABLE BATTERY PACK

(71) Applicant: SAMSUNG SDI CO., LTD., Yongin-si (KR)

(72) Inventors: Se Hyeong LEE, Suwon-si (KR); Young Gwang CHOI, Suwon-si (KR)

(73) Assignee: SAMSUNG SDI CO., LTD., Yongin-si (KR)

(21) Appl. No.: 19/656,023

(22) Filed: Apr. 23, 2026

(30) Foreign Application Priority Data
Apr. 30, 2025 (KR) 10-2025-0057221

(51) Int. Cl. H01M 10/42; H01M 50/103; H01M 50/15; H01M 50/209; H01M 50/423; H01M 50/449; H01M 50/489; H01M 50/55

(52) U.S. Cl. CPC H01M 10/4235; H01M 50/103; H01M 50/15; H01M 50/209; H01M 50/423; H01M 50/449; H01M 50/489; H01M 50/55

(57) ABSTRACT

The present disclosure relates to a rechargeable battery, and a rechargeable battery pack including the rechargeable battery. The rechargeable battery includes a case, an electrode assembly disposed inside the case and having a first electrode, a separator, and a second electrode, a cap assembly that seals the case and has a first terminal and a second terminal, a first tab member extending from the electrode assembly in a first direction, and a first current collector connected to the first terminal and the first tab member. The separator includes one or more of a porous substrate and a coating layer, and a resin layer having a higher melting point than each of the porous substrate and the coating layer, and the resin layer faces the first current collector.

### CROSS-REFERENCE TO RELATED APPLICATION

The present application claims priority and the benefit of Korean Patent Application No. 10-2025-0057221, filed on Apr. 30, 2025 in the Korean Intellectual Property Office, the entire disclosure of which is incorporated herein by reference.

### BACKGROUND

### 1. Field of the Disclosure

The present disclosure relates to a rechargeable battery, and a rechargeable battery pack including the rechargeable battery.

### 2. Discussion of Related Art

With increasing presence of electronic devices such as, e.g., mobile phones, notebook computers, electric vehicles, and the like that use batteries, the demand for secondary batteries having high energy density and high capacity is increasing. Therefore, improving the performance of rechargeable lithium batteries may be advantageous.

A rechargeable lithium battery includes a positive electrode and a negative electrode that contain an active material capable of the intercalation and deintercalation of lithium ions. The rechargeable lithium battery produces electric energy by oxidation and reduction reactions when the lithium ions are intercalated into and deintercalated from the positive electrode and the negative electrode. A rechargeable lithium battery may include a separator between the positive electrode and the negative electrode.

### SUMMARY

One example embodiment is directed to providing a rechargeable battery and a rechargeable battery pack in which a separator is not damaged when welded between a current collector and a tab member.

Another example embodiment is directed to providing a rechargeable battery and a rechargeable battery pack, which have improved battery capacity due to a separator not being damaged even when a length of a tab member is short.

According to one example embodiment, there is provided a rechargeable battery including a case, an electrode assembly disposed inside the case and having a first electrode, a separator, and a second electrode, a cap assembly that seals the case and has a first terminal and a second terminal, a first tab member extending from the electrode assembly in a first direction, and a first current collector connected to the first terminal and the first tab member, wherein the separator includes one or more of a porous substrate and a coating layer; and a resin layer having a higher melting point than each of the porous substrate and the coating layer, and the resin layer faces the first current collector.

According to another example embodiment, there is provided a rechargeable battery pack including a housing, and a plurality of rechargeable batteries disposed inside the housing, wherein each of the rechargeable batteries includes a case, an electrode assembly disposed inside the case and having a first electrode, a separator, and a second electrode, a cap assembly that seals the case and has a first terminal and a second terminal, a first tab member extending from the electrode assembly in a first direction, and a first current collector connected to the first terminal and the first tab member, the separator includes one or more of a porous substrate and a coating layer, the separator includes a resin layer having a higher melting point than each of the porous substrate and the coating layer, and the resin layer faces the first current collector.

### BRIEF DESCRIPTION OF THE DRAWINGS

The following drawings attached to the present specification illustrate example embodiments of the present disclosure and further describe aspects and features of the present disclosure together with the detailed description of the present disclosure. Thus, the present disclosure should not be construed as being limited to the drawings, in which:

FIG. 1 is a schematic perspective view showing a configuration of a rechargeable battery according to one example embodiment of the present disclosure;

FIG. 2 is a schematic exploded perspective view showing a configuration of a rechargeable battery according to one example embodiment of the present disclosure;

FIG. 3 is a schematic view showing a configuration of an electrode assembly according to one example embodiment of the present disclosure;

FIG. 4 is a schematic perspective view showing the configuration of the electrode assembly according to one example embodiment of the present disclosure;

FIG. 5 is a schematic cross-sectional view showing a configuration of a first current collector and the electrode assembly according to one example embodiment of the present disclosure;

FIG. 6 is a schematic cross-sectional view showing a configuration of an electrode assembly of a rechargeable battery according to another example embodiment of the present disclosure;

FIG. 7 is a schematic cross-sectional view showing a configuration of a first current collector and an electrode assembly according to still another example embodiment of the present disclosure; and

FIG. 8 is a schematic perspective view showing a configuration of a battery pack according to one example embodiment of the present disclosure.

### DETAILED DESCRIPTION

Hereinafter, example embodiments of the present disclosure are described in detail with reference to the attached drawings. It should be noted that the terms and words used in this specification and claims should not be construed as limited to their conventional or dictionary meanings. The terms and words used in this specification and claims should be interpreted in a way that reflects the technical spirit of the present disclosure. Therefore, the example embodiments described in this specification and the configurations depicted in the drawings represent only some of the example embodiments of the present disclosure, and do not represent the entire technical spirit of the present disclosure. Therefore, it should be understood that various equivalents and modifications may be substituted for them at the time of filing.

Furthermore, as used herein, the terms “comprise” and “include” and/or “comprising” and “including” specify the presence of stated shapes, numbers, steps, operations, elements, components, and/or groups thereof, and do not preclude the presence or addition of one or more other shapes, numbers, operations, elements, elements, and/or groups. Furthermore, to facilitate understanding of the disclosure, the attached drawings may not be drawn to scale and the dimensions of some components may be exaggerated. Furthermore, identical components in different embodiments may be assigned the same reference numerals.

References to two compared objects being “identical” mean “substantially identical.” Therefore, “substantially identical” may include variations considered low in the art, for example, within 5%. Furthermore, uniformity of a parameter over a given region may imply uniformity on average.

Although terms such as “first,” “second,” and the like, are used to describe various components, these components are not limited by these terms. These terms are used solely to distinguish one component from another. Unless otherwise specified, a “first” component may also be a “second” component.

Throughout the specification, unless otherwise specified, each component may be singular or plural. The term “above (or below)” or “above (or below)” a component may not only mean that the component is positioned in contact with the top (or bottom) surface of the component, but also that other components may be interposed between the component and any component positioned above (or below) the component.

Furthermore, when a component is described as being “on,” “connected to,” or “coupled to” another component, it should be understood that the components may be directly connected or coupled to each other, but that other components may also be “interposed” between the components, or that the components may be “connected,” “coupled,” or “connected” through other components.

As used herein, the term “and/or” encompasses any and all combinations of one or more of the associated listed items. Furthermore, the use of “may” when describing example embodiments of the present disclosure refers to “one or more example embodiments of the present disclosure.” Expressions such as “one or more” and “at least one of” before a list of elements modify the entire list of elements and do not modify individual elements within the list.

Throughout the specification, references to “A and/or B” mean A, B, or A and B, unless otherwise stated. References to “C through D” mean C or more and D or less, unless otherwise stated.

When phrases such as “at least one of A, B, and C” or “at least one of A, B, or C” are used to designate a list of elements A, B, and C, the phrases may refer to any suitable combination.

The term “use” may be considered synonymous with the term “utilize.” As used herein, the terms “substantially,” “about,” and similar terms are used as terms of approximation, not degrees, and are intended to take into account inherent variations in measured or calculated values that may be recognized by those of ordinary skill in the art.

Although terms such as “first,” “second,” “third,” and the like, may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could also be termed a second element, component, region, layer, or section without departing from the teachings of the example embodiments. For ease of explanation, spatially relative terms such as “beneath,” “below,” “lower,” “above,” and “upper” may be used herein to describe the relationship between one element or feature and another element(s) or feature(s) as depicted in the drawings. It is understood that spatially relative positions encompass different orientations of the device in use or operation, in addition to the orientation depicted in the figures. For example, if the device in the drawings is flipped over, an element described as “beneath” or “lower” would be understood as “above” or “upper” the other element. Thus, the term “beneath” can encompass both the above and below orientations.

The terminology used herein is intended to describe example embodiments of the present disclosure, and is not intended to be limiting.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

According to one example embodiment, a rechargeable battery and a rechargeable battery pack are not damaged since a separator is not damaged when welded between a current collector and a tab member. Accordingly, the rechargeable battery can reduce the probability of occurrence of a short circuit during operation of the battery and reduce or prevent degradation of battery performance.

According to another example embodiment, a rechargeable battery and a rechargeable battery pack include a separator that is not damaged even when a length of a tab member is short. Accordingly, the rechargeable battery can increase an area of an active material layer in an electrode assembly, thereby increasing the capacity of the battery.

According to one example embodiment, a rechargeable battery includes a case, an electrode assembly disposed inside the case and having a first electrode, a separator, and a second electrode, a cap assembly that seals the case and has a first terminal and a second terminal, a first tab member extending from the electrode assembly in a first direction, and a first current collector connected to the first terminal and the first tab member, wherein the separator includes one or more of a porous substrate and a coating layer; and a resin layer having a higher melting point than each of the porous substrate and the coating layer, and the resin layer faces the first current collector.

According to another example embodiment, a rechargeable battery pack includes a housing, and a plurality of rechargeable batteries disposed inside the housing, wherein each of the rechargeable batteries includes a case, an electrode assembly disposed inside the case and having a first electrode, a separator, and a second electrode, a cap assembly that seals the case and has a first terminal and a second terminal, a first tab member extending from the electrode assembly in a first direction, and a first current collector connected to the first terminal and the first tab member, the separator includes one or more of a porous substrate and a coating layer; and a resin layer having a higher melting point than each of the porous substrate and the coating layer, and the resin layer faces the first current collector.

In the present specification, “melting point” may be measured by the conventional method known to those skilled in the art. For example, the melting point may be measured by, e.g., a differential scanning calorimeter (DSC), but the measurement method is not limited thereto.

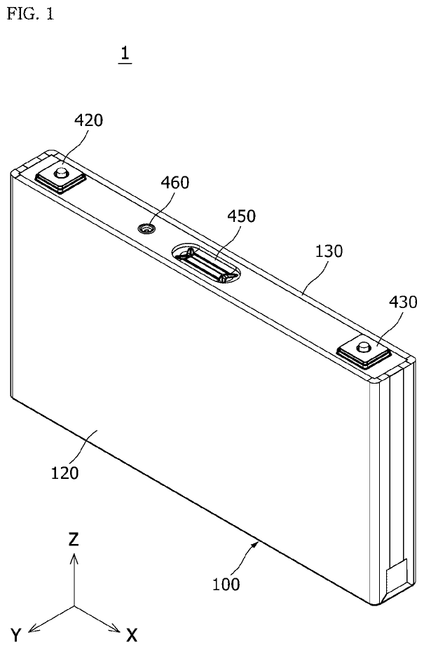

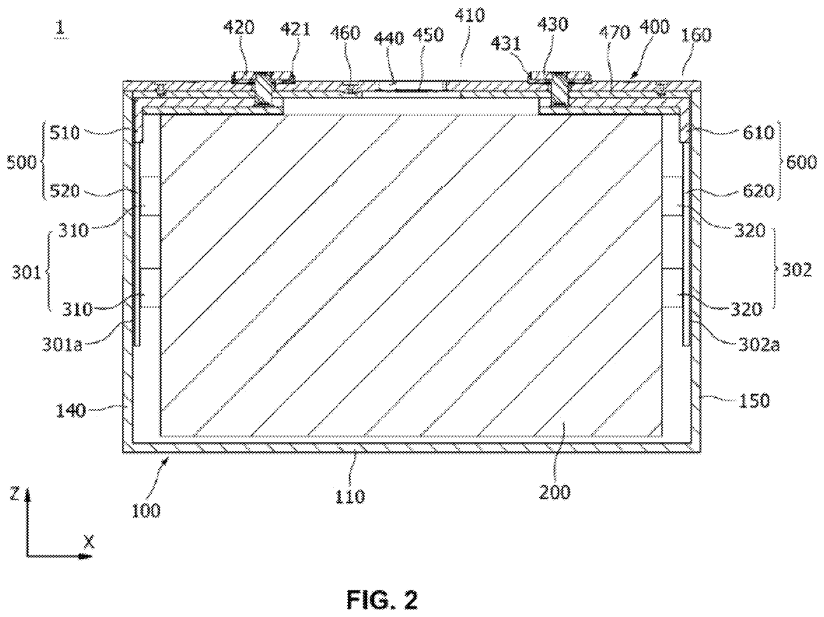

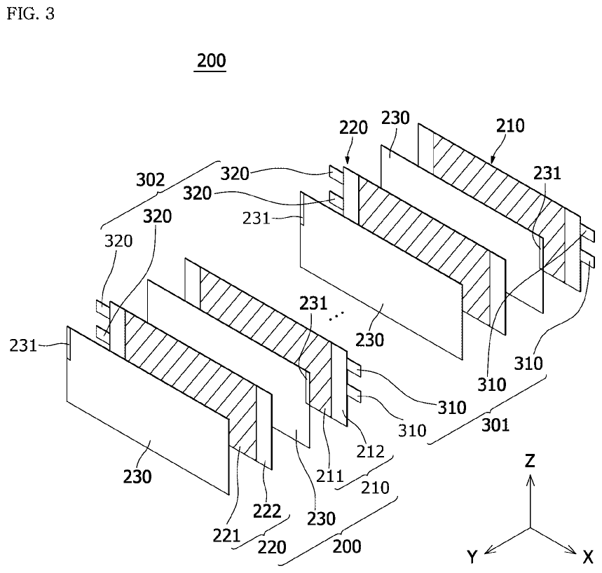

FIG. 1 is a schematic perspective view showing a configuration of a rechargeable battery according to one example embodiment of the present disclosure, FIG. 2 is a schematic exploded perspective view showing a configuration of a rechargeable battery according to one example embodiment of the present disclosure, and FIG. 3 is a schematic view showing a configuration of an electrode assembly according to one example embodiment of the present disclosure.

Hereinafter, an example in which the rechargeable battery is a prismatic lithium ion rechargeable battery is described below. However, the present disclosure is not limited thereto, and the rechargeable battery may be or include a lithium polymer battery or cylindrical battery.

Referring to FIG. 1 to FIG. 3, a rechargeable battery 1 according to the present example embodiment includes a case 100, an electrode assembly 200, a first tab member 301, a cap assembly 400, a first current collector 500 and a second current collector 600.

The case 100 may form an approximate exterior of the rechargeable battery 1 and accommodate the electrode assembly 200.

The case 100 may include a bottom portion 110, a front portion 120, a back portion 130, a first side portion 140, and a second side portion 150.

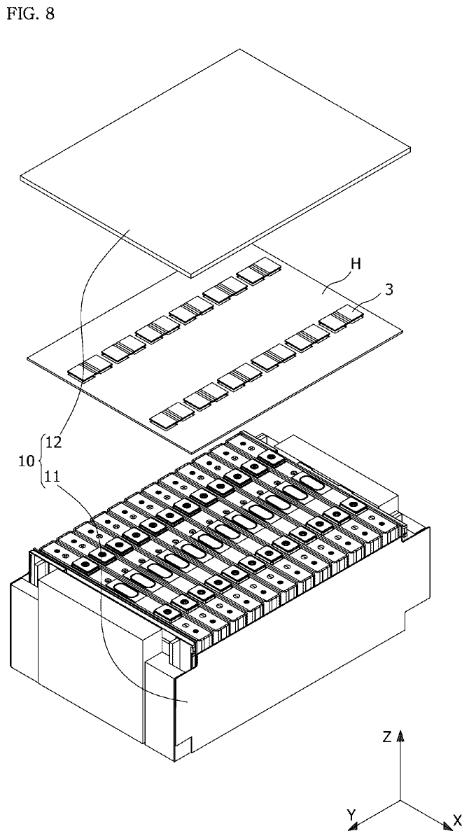

The bottom portion 110 may form an exterior of a lower side (based on FIG. 1) of the case 100. The bottom portion 110 according to the present example embodiment may have a rectangular, or substantially rectangular, plate shape. The bottom portion 110 may be seated on a bottom surface of a housing body 11 illustrated in FIG. 8.

The front portion 120, the back portion 130, the first side portion 140, and the second side portion 150 may form an outer surface of the case 100.

The front portion 120, the back portion 130, the first side portion 140, and the second side portion 150 may have a plate shape that extends upward (based on FIG. 2) from an edge of the bottom portion 110. The front portion 120, the back portion 130, the first side portion 140, and the second side portion 150 may be disposed to surround the space above the bottom portion 110. The front portion 120, the back portion 130, the first side portion 140, and the second side portion 150 may be disposed to form a rectangular, or substantially rectangular, cross-sectional shape.

The front portion 120 and the back portion 130 may be disposed to face each other in a longitudinal direction of the rechargeable battery 1. The front portion 120 and the back portion 130 may be disposed in parallel. Areas of the front portion 120 and the back portion 130 may be the same.

The first side portion 140 and the second side portion 150 may be disposed to face each other in a width direction of the rechargeable battery 1. The first side portion 140 and the second side portion 150 may be disposed in parallel. Areas of the first side portion 140 and the second side portion 150 may be the same. The areas of the first side portion 140 and the second side portion 150 may be smaller than the areas of the front portion 120 and the back portion 130.

The case 100 may further include an opening 160. The opening 160 according to the present example embodiment may be a space surrounded by upper end portions of the front portion 120, the back portion 130, the first side portion 140, and the second side portion 150. The opening 160 may connect the space inside and outside the case 100.

Therefore, the case 100 according to the present example embodiment may have a rectangular parallelepiped, or substantially rectangular parallelepiped, shape with an open upper side.

A first direction to be described below may be a direction that is parallel to an X-axis based on FIG. 2 and a direction from the first side portion 140 to the second side portion 150. A second direction may be a direction that is parallel to a Y-axis based on FIG. 1 and a direction from the back portion 130 to the front portion 120. A third direction may be a direction that is parallel to a Z-axis based on FIG. 2 and a direction from the bottom portion 110 to the opening 160.

The electrode assembly 200 may constitute a unit structure that performs the charging and discharging operation of power in a rechargeable battery. The electrode assembly 200 may be accommodated inside the case 100.

As illustrated in FIG. 3, the electrode assembly 200 may include a first electrode 210, a second electrode 220, and a separator 230 disposed between the first electrode 210 and the second electrode 220. A plurality of first electrodes 210, separators 230, and second electrodes 220 may be provided.

Hereinafter, an example in which the electrode assembly 200 has a stacked form in which a plurality of first electrodes 210, separators 230, and second electrodes 220 are sequentially stacked in the second direction is described below. However, the electrode assembly 200 is not limited thereto, and may have a form in which the first electrodes 210, the separators 230, and the second electrodes 220 in a stacked state are wound around a winding axis in a clockwise or counterclockwise direction.

The first electrode 210 may constitute one of a positive electrode and a negative electrode of the electrode assembly 200. Hereinafter, an example in which the first electrode 210 is the positive electrode of the electrode assembly 200 is described below. However, the first electrode 210 is not limited thereto and may constitute the negative electrode of the electrode assembly 200.

The first electrode 210 according to the present example embodiment may have the form of a foil including a metal material such as aluminum or an aluminum alloy. The type, size, shape, and the like of the first electrode 210 are not particularly limited as long as the first electrode 210 has conductivity without causing an adverse chemical change in a rechargeable battery. A cross-sectional shape of the first electrode 210 may be designed to have various shapes in addition to the rectangular, or substantially rectangular, shape shown in FIG. 3.

A plurality of first electrodes 210 may be provided. The plurality of first electrodes 210 may be arranged in the second direction between the front portion 120 and the back portion 130 of the case 100. The number of first electrodes 210 may be variously designed depending on the charging capacity, or the like, of the rechargeable battery 1.

As illustrated in FIG. 3, a first active material layer 211 may be applied on at least a portion of the first electrode 210. The first active material layer 211 may be applied on both surfaces of the first electrode 210 or alternatively, applied on only one surface of the first electrode 210.

In the present example embodiment, since the first electrode 210 constitutes a positive electrode, the first active material layer 211 may include a positive electrode active material.

The positive electrode active material may be or include a compound capable of reversible intercalation and deintercalation of lithium (a lithiated intercalation compound). For example, as the positive electrode active material, one or more of composite oxides of a metal such as or including at least one of cobalt, manganese, nickel, iron, and a combination thereof and lithium may be used.

As an example, the positive electrode active material may include at least one of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, NCM). Here, 0<x<1, 0<y<1, 0<z<1, and x+y+z=1 may be satisfied. The positive electrode active material may include only one of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn₂O₂, NCM), and may include two or all of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, NCM).

The first active material layer 211 may further include a positive electrode conductive material.

The positive electrode conductive material may impart conductivity to the first active material layer 211, and any material that is an electronically conductive material without causing an adverse chemical change in the battery may be used. Examples of the positive electrode conductive material may include carbon-based materials, such as at least one of natural graphite, artificial graphite, carbon black, acetylene black, Ketjen black, carbon fibers, carbon nanofibers, carbon nanotubes, and the like, metal-based materials in the form of metal powder or metal fibers containing at least one of copper, nickel, aluminum, silver, and the like, conductive polymers, such as polyphenylene derivatives, and the like, or a mixture thereof.

The first active material layer 211 may further include a positive electrode binder.

The positive electrode binder attaches particles constituting the positive electrode active material, and attaches the positive electrode active material to the first electrode 210.

Examples of the positive electrode binder may include a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be or include at least one of styrene-butadiene rubber, (meth)acrylated styrene-butadiene rubber, (meth)acrylonitrile-butadiene rubber, (meth)acrylic rubber, butyl rubber, a fluoroelastomer, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and a combination thereof.

When the aqueous binder is used as the positive electrode binder, the aqueous binder may further include a cellulose-based compound capable of imparting viscosity. As the cellulose-based compound, one or more of carboxymethyl cellulose, hydroxypropylmethyl cellulose, methyl cellulose, and an alkali metal salt thereof may be mixed and used. The alkali metal may be or include at least one of Na, K, or Li.

The dry binder may be or include a polymer material capable of being fiberized, for example, at least one of polytetrafluoroethylene, polyvinylidene fluoride, a polyvinylidene fluoride-hexafluoropropylene copolymer, polyethylene oxide, or a combination thereof.

The first electrode 210 may include a first uncoated portion 212 on which the first active material layer 211 is not applied. The first uncoated portion 212 according to the present example embodiment may be disposed in one end portion region of the first electrode 210 disposed to face the first side portion 140 inside the case 100. However, the first uncoated portion 212 is not limited thereto and may be formed over the entire edge region of the first electrode 210.

The second electrode 220 may constitute one of a positive electrode and a negative electrode of the electrode assembly 200. Hereinafter, an example in which the second electrode 220 is the negative electrode of the electrode assembly 200 is described below. However, the second electrode 220 is not limited thereto and may constitute the positive electrode of the electrode assembly 200.

A plurality of second electrodes 220 may be provided. The plurality of second electrodes 220 may be arranged in the second direction between the front portion 120 and the back portion 130 of the case 100. The first electrode 210 and the second electrode 220 may be alternately disposed in the second direction. The second electrode 220 may be spaced at a predetermined or desired distance from the first electrode 210 in the second direction.

The second electrode 220 according to the present example embodiment may have the form of a foil including a metallic material such as or including at least one of copper, a copper alloy, nickel, or a nickel alloy. The type, size, shape, and the like of the second electrode 220 are not particularly limited, as long as the second electrode 220 has conductivity without causing an adverse chemical change in the rechargeable battery. A cross-sectional shape of the second electrode 220 may be designed to have various shapes in addition to the rectangular, or substantially rectangular, shape shown in FIG. 3.

A second active material layer 221 may be applied on at least a portion of the second electrode 220. The second active material layer 221 may be applied on both surfaces of the second electrode 220, or alternatively may be applied on only one surface of the second electrode 220.

Since the second electrode 220 constitutes a negative electrode, the second active material layer 221 may include a negative electrode active material.

The negative electrode active material may include at least one of a material capable of reversible intercalation/deintercalation of lithium ions, lithium metal, an alloy of lithium and a metal, a material capable of doping and dedoping lithium, or a transition metal oxide.

The material capable of reversibly intercalating/deintercalating lithium ions may be or include a carbon-based negative electrode active material, which may include, for example, crystalline carbon, amorphous carbon, or a combination thereof. An example of crystalline carbon may include graphite such as amorphous, plate-like, flaky, spherical, or fibrous natural graphite or artificial graphite, and examples of amorphous carbon may include at least one of soft carbon, hard carbon, mesophase pitch carbide, calcined coke, and the like.

As the alloy of lithium and a metal, an alloy of lithium and a metal such as or including at least one of Na, K, Rb, Cs, Fr, Be, Mg, Ca, Sr, Si, Sb, Pb, In, Zn, Ba, Ra, Ge, Al, and Sn may be used.

As the material capable of doping and dedoping lithium, a Si-based negative electrode active material or a Sn-based negative electrode active material may be used. The Si-based negative electrode active material may be or include at least one of silicon, a silicon-carbon composite, SiOₓ (0<x<2), a Si-Q alloy (Q is or includes at least one of an alkali metal, an alkaline earth metal, a Group 13 element, a Group 14 element (excluding Si), a Group 15 element, a Group 16 element, a transition metal, a rare earth element, and a combination thereof), or a combination thereof. The Sn-based negative electrode active material may be or include at least one of Sn, SnO₂, a Sn-based alloy, or a combination thereof.

The silicon-carbon composite may be or include a composite of silicon and amorphous carbon. According to one example embodiment, the silicon-carbon composite may be in the form of silicon particles which surfaces are coated with amorphous carbon. For example, the silicon-carbon composite may include a secondary particle (core) in which primary silicon particles are aggregated and an amorphous carbon coating layer (shell) located on a surface of the secondary particle. The amorphous carbon may be located between the primary silicon particles, for example, so that the primary silicon particles may be coated with amorphous carbon. The secondary particles may be dispersed in an amorphous carbon matrix.

The silicon-carbon composite may further include crystalline carbon. For example, the silicon-carbon composite may include a core including crystalline carbon and silicon particles, and an amorphous carbon coating layer located on a surface of the core.

The Si-based negative electrode active material or Sn-based negative electrode active material may be used in combination with a carbon-based negative electrode active material.

The second active material layer 221 may further include a negative electrode conductive material and a negative electrode binder.

The negative electrode conductive material may impart conductivity to the second active material layer 221, and any material that is an electrically conductive material without causing an adverse chemical change in the battery may be used. Examples of the negative electrode conductive material may include carbon-based materials such as at least one of natural graphite, artificial graphite, carbon black, acetylene black, Ketjen black, carbon fibers, carbon nanofibers, carbon nanotubes, and the like, metal-based materials in the form of metal powder or metal fibers containing at least one of copper, nickel, aluminum, silver, and the like, conductive polymers such as polyphenylene derivatives and the like, or a mixture thereof.

The negative electrode binder attaches particles constituting the negative electrode active material, and attaches the negative electrode active material to the second electrode 220.

Examples of the negative electrode binder may include a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be or include at least one of styrene-butadiene rubber, (meth)acrylated styrene-butadiene rubber, (meth)acrylonitrile-butadiene rubber, (meth)acrylic rubber, butyl rubber, a fluoroelastomer, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and a combination thereof.

When the aqueous binder is used as the negative electrode binder, the aqueous binder may further include a cellulose-based compound capable of imparting viscosity. As the cellulose-based compound, one or more of carboxymethyl cellulose, hydroxypropylmethyl cellulose, methyl cellulose, and an alkali metal salt thereof may be mixed and used. The alkali metal may be or include at least one of Na, K, or Li.

The dry binder may be or include a polymer material capable of being fibered, for example, at least one of polytetrafluoroethylene, polyvinylidene fluoride, a polyvinylidene fluoride-hexafluoropropylene copolymer, polyethylene oxide, or a combination thereof.

The second electrode 220 may include a second uncoated portion 222 on which the second active material layer 221 is not applied. The second uncoated portion 222 according to the present example embodiment may be disposed in the other end portion region of the second electrode 220 disposed to face the second side portion 150 inside the case 100. However, the second uncoated portion 222 is not limited thereto and may be formed over the entire edge region of the second electrode 220.

The separator 230 may be disposed between the first electrode 210 and the second electrode 220. The separator 230 may reduce or prevent a short circuit between the first electrode 210 and the second electrode 220 while allowing the movement of lithium ions between the first electrode 210 and the second electrode 220.

The separator 230 may be disposed to completely cover a surface region of the electrode assembly 200. Therefore, the separator 230 may reduce or prevent the first electrode 210 and the second electrode 220 from being directly exposed to the outside of the electrode assembly 200.

As the separator 230, at least one of polyethylene, polypropylene, polyvinylidene fluoride or a multilayered membrane of two or more layers thereof may be used, and a mixed multilayered membrane such as a polyethylene/polypropylene two-layer separator, a polyethylene/polypropylene/polyethylene three-layer separator, or a polypropylene/polyethylene/polypropylene three-layer separator may be used.

The separator 230 may include a porous substrate and a coating layer including an organic material, an inorganic material, or a combination thereof, and is positioned on one surface, or on both surfaces of the porous substrate.

The porous substrate may be or include a polymer film formed of or including one polymer such as or including at least one of polyolefins such as polyethylene and polypropylene, polyesters such as polyethylene terephthalate and polybutylene terephthalate, polyacetal, polyamide, polyimide, polycarbonate, polyether ketone, polyarylether ketone, polyetherimide, polyamideimide, polybenzimidazole, polyether sulfone, polyphenylene oxide, cyclic olefin copolymers, polyphenylene sulfide, polyethylene naphthalate, glass fiber, Teflon, and polytetrafluoroethylene, or a copolymer or mixture of two or more of the above materials.

The organic material may include a polyvinylidene fluoride-based polymer or a (meth)acrylic polymer.

The inorganic material may include inorganic particles such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be present as a mixture in one coating layer, or in the form of a coating layer containing an organic material and a coating layer containing an inorganic material that are stacked on each other.

The separator 230 further includes a resin layer 231 to be described below. The resin layer 231 is described in detail below.

The first tab member 301 may be connected to the first electrode 210. As the first electrode 210 is exemplified as a positive electrode, the first tab member 301 may constitute a positive electrode tab of the rechargeable battery 1. However, the first tab member 301 is not limited thereto, and when the first electrode 210 is a negative electrode, the first tab member 301 may constitute a negative electrode tab of the rechargeable battery 1.

The first tab member 301 may extend from the electrode assembly 200 in the first direction. For example, the first tab member 301 may extend from the electrode assembly 200 toward the first side portion 140 inside the case 100.

A plurality of first tab members 301 may be provided. The plurality of first tab members 301 may be arranged in the third direction. As an example, a pair of first tab members 301 according to the present example embodiment may be formed, and the pair of first tab members 301 may be disposed to be spaced at a predetermined or desired distance from each other in the third direction.

The first tab member 301 according to the present example embodiment may include a plurality of first tabs 310.

The first tab 310 according to the present example embodiment may have the form of a foil extending from the first uncoated portion 212 of the first electrode 210 in the first direction. The first tab 310 may have a substantially rectangular shape. However, the shape of the first tab 310 is not limited thereto and may be designed to have various shapes.

The first tab 310 may be integrally formed with the first electrode 210.

The number of first tabs 310 may be the same as the number of first electrodes 210. Each first tab 310 may individually extend from the first uncoated portion 212 of a different first electrode 210. Neighboring first tabs 310 may face each other in the second direction. That is, a plurality of first tabs 310 may be arranged in the second direction. Neighboring first tabs 310 may be disposed in parallel. Therefore, the first tab member 301 according to the present example embodiment may be an assembly of the plurality of first tabs 310 arranged in the second direction. In addition, the first end portion surface 301a may be an assembly of end portion surfaces of the plurality of first tabs 310 arranged in the second direction. Neighboring first tabs 310 may be in contact with each other, and may also be spaced apart by a thickness of the separator 230.

The rechargeable battery 1 according to the present example embodiment may further include a second tab member 302.

The second tab member 302 may be connected to the second electrode 220. As the second electrode 220 is exemplified as a negative electrode, the second tab member 302 may constitute a negative electrode tab of the rechargeable battery 1. However, the second tab member 302 is not limited thereto, and when the second electrode 220 is a positive electrode, the second tab member 302 may constitute a positive electrode tab of the rechargeable battery 1.

The second tab member 302 may extend from the electrode assembly 200 in a direction opposite to the first direction. For example, the second tab member 302 may extend from the electrode assembly 200 toward the second side portion 150 inside the case 100. That is, the first tab member 301 and the second tab member 302 may extend in opposite directions from the electrode assembly 200.

A plurality of second tab members 302 may be provided. The plurality of second tab members 302 may be arranged in the third direction. As an example, a pair of second tab members 302 according to the present example embodiment may be formed, and the pair of second tab members 302 may be disposed to be spaced at a predetermined or desired distance from each other in the third direction.

The second tab member 302 may include a plurality of second tabs 320.

The second tab 320 according to the present example embodiment may have the form of a foil extending from the second uncoated portion 222 of the second electrode 220 in a direction opposite to the first direction. The second tab 320 may have a substantially rectangular shape. However, the shape of the second tab 320 is not limited thereto and the second tab 320 may be designed to have various shapes.

The second tab 320 may be integrally formed with the second electrode 220. For example, the second tab 320 may be the remaining region of the second uncoated portion 222 that remains after a partial region of the second uncoated portion 222 is cut or removed by notching processing or the like. Alternatively, the second tab 320 may be manufactured separately from the second electrode 220, and then connected to the second uncoated portion 222 by welding or the like. A material of the second tab 320 may be the same as the material of the second electrode 220.

The number of second tabs 320 may be the same as the number of second electrodes 220. Each second tab 320 may individually extend from the second uncoated portion 222 of a different second electrode 220. Neighboring second tabs 320 may be disposed to face each other in the second direction. That is, a plurality of second tabs 320 may be arranged in the second direction. Neighboring second tabs 320 may be disposed in parallel. Therefore, the second tab member 302 according to the present example embodiment may be an assembly of the plurality of second tabs 320 arranged in the second direction. In addition, the second end portion surface 302a may be an assembly of end portion surfaces of the plurality of second tabs 320 arranged in the second direction. Neighboring second tabs 320 may be in contact with each other and may also be spaced apart by the thickness of the separator 230.

The cap assembly 400 may be coupled to the case 100 to seal the case 100. The cap assembly 400 may be disposed to face the electrode assembly 200 in the third direction.

The cap assembly 400 may include the cap plate 410, a first terminal 420, and a second terminal 430.

The cap plate 410 may form an approximate exterior of the cap assembly 400, and may support both the first terminal 420 and the second terminal 430.

The cap plate 410 may have a flat shape. The cap plate 410 may be disposed in the opening 160 of the case 100. The cap plate 410 may be disposed to face the electrode assembly 200 in the third direction parallel to the Z-axis. That is, the cap plate 410 may be disposed at a location spaced at a predetermined or desired distance from the electrode assembly 200 in the third direction. The cap plate 410 may be disposed parallel to the bottom portion 110 of the case 100.

The cap plate 410 may be seated on an upper end portion of the case 100, for example, upper end portions of the front portion 120, the back portion 130, the first side portion 140, and the second side portion 150. The cap plate 410 may be connected to the case 100 by various types of coupling methods such as, e.g., welding, bolting, fitting, and the like.

The first terminal 420 may protrude outward from the cap plate 410. The first terminal 420 may be electrically connected to the first electrode 210. Since the first electrode 210 according to the present example embodiment constitutes a positive electrode, the first terminal 420 may be exemplified as a positive electrode terminal of the rechargeable battery 1.

The first terminal 420 may be inserted into the cap plate 410. An upper end portion of the first terminal 420 may protrude from the cap plate 410 in the third direction. Although FIG. 2 shows an example in which the first terminal 420 has a rectangular, or substantially rectangular, cross-sectional shape, the cross-sectional shape of the first terminal 420 is not limited thereto and may be designed to have various shapes such as a circle, oval, polygon, and the like. The first terminal 420 may be formed of or include an electrically conductive material such as, e.g., aluminum, nickel, copper, and the like.

The second terminal 430 may protrude outward from the cap plate 410 at a location spaced apart from the first terminal 420. The second terminal 430 may be electrically connected to the second electrode 220. Since the second electrode 220 according to the present example embodiment constitutes a negative electrode, the second terminal 430 may be exemplified as a negative electrode terminal of the rechargeable battery 1.

The second terminal 430 may be inserted into the cap plate 410. An upper end portion of the second terminal 430 may protrude from the cap plate 410 in the third direction. Although FIG. 2 shows an example in which the second terminal 430 has a rectangular, or substantially rectangular, cross-sectional shape, the cross-sectional shape of the second terminal 430 is not limited thereto and may be designed to have various shapes such as a circle, oval, polygon, and the like. The second terminal 430 may be formed of or include an electrically conductive material such as aluminum, nickel, copper, and the like. The second terminal 430 may be disposed at a location spaced at a predetermined or desired distance from the first terminal 420 in the first direction.

A first gasket 421 may be installed between the cap plate 410 and the first terminal 420. A second gasket 431 may be installed between the cap plate 410 and the second terminal 430. The cap assembly 400 may further include a vent hole 440, a vent 450, an electrolyte injection port 460, and an insulating plate 470. The vent hole 440 and the vent 450 are conventional components and thus descriptions thereof are omitted.

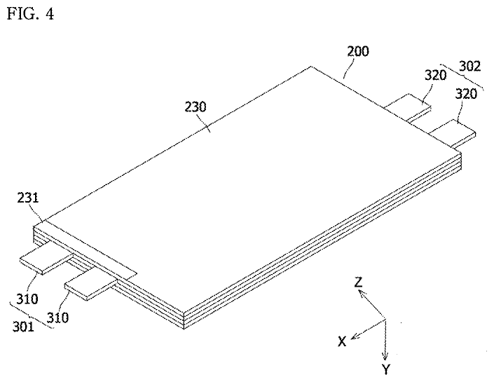

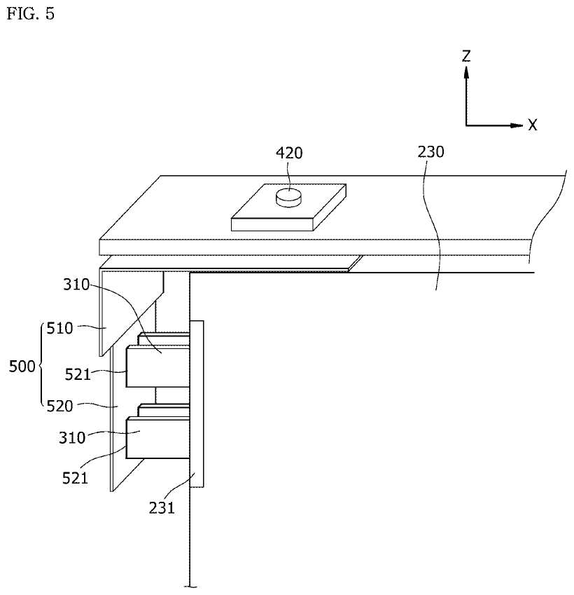

A rechargeable battery according to one example embodiment of the present disclosure is described in detail below with reference to FIG. 4 and FIG. 5.

The separator 230 includes a resin layer 231. The resin layer 231 includes a resin having a higher melting point than each of the porous substrate and the coating layer. Accordingly, since the separator 230 has higher heat resistance, damage to the separator can be reduced when the separator is exposed to heat during the battery manufacturing process, or during charging and discharging of the battery.

The first current collector 500 may be connected to the first terminal 420 and the electrode assembly 200, and may electrically connect the first terminal 420 and the electrode assembly 200. The first current collector 500 may be formed of or include an electrically conductive material such as, e.g., aluminum, copper, nickel, and the like.

The first current collector 500 may include a first terminal plate 510 and a first current collector plate 520.

The first terminal plate 510 may be connected to the first terminal 420 and disposed between the electrode assembly 200 and the first terminal 420. The first terminal plate 510 may be spaced at a predetermined or desired distance from a lower surface of the first terminal 420 in the third direction. The first terminal plate 510 may be mechanically and electrically connected to the first terminal 420 by riveting, bolting, and the like. Alternatively, the first terminal plate 510 may be in direct contact with the lower surface of the first terminal 420, and mechanically and electrically connected to the first terminal 420 by welding or the like.

The first current collector plate 520 may extend from the first terminal plate 510 in a direction opposite to the third direction. The first current collector plate 520 may be located between the first tab member 301 (e.g., the first tab 310) and the first terminal plate 510, and the first current collector plate 520 may be connected to the first tab member 301 (e.g., the first tab 310).

The first tab member 301 (e.g., the first tab 310) may be connected to the first current collector plate 520 by welding.

The welding may include welding by laser irradiation but is not limited thereto. Hereinafter, the welding by laser irradiation is described, but the welding method is not particularly limited as long as heat is applied, even when heat is not applied by a laser.

Welding is a method of irradiating a laser onto the first current collector plate 520 to apply heat, which melts the first current collector plate 520, and then joining the first tab member 301 (e.g., the first tab 310). For example, welding may form a first welding line 521 on the first current collector plate 520 by applying heat to the first current collector plate 520 to melt the first current collector plate 520, and the first tab member 301 (e.g., the first tab 310) may be connected to the first welding line 521.

A plurality of first welding lines 521 may be formed on the first current collector plate 520 depending on the number of first tab members 301 (e.g., the first tab 310). Alternatively, the first welding lines 521 may be connected to form a single welding area.

Welding can enhance the reliability of the battery by reducing or preventing the first current collector plate 520 and the first tab member 301 (e.g., the first tab 310) from being separated from each other during charging and discharging of the battery. However, welding can damage the separator 230, particularly at a portion facing the first current collector 500, particularly a portion facing the first welding line 521.

The resin layer 231 faces the first current collector 500. Here, “facing” means that the resin layer 231 is formed to extend in the third direction (Z-axis) in FIGS. 4 and 5, and the first current collector 500 is formed in the same direction as the direction in which the resin layer 231 is formed to extend. Accordingly, the resin layer 231 can reduce or prevent damage to the separator 230 due to the heat generated during the welding. In addition, the resin layer 231 can increase the capacity of the battery by reducing or preventing damage to the separator even when a length of the first tab member 310 is shortened. A method of forming the separator 230 itself with a resin included in the resin layer may be considered, but the air permeability of the separator 230 may be increased.

The resin layer 231 may face the first current collector plate 520 of the first current collector 500. Here, “facing” means that the resin layer 231 is formed to extend in the third direction (Z-axis) in FIGS. 4 and 5, and the direction (i.e., the third direction) in which the resin layer 231 is formed to extend is the same as the longitudinal direction of the first current collector plate 520. Accordingly, the resin layer 231 can reduce or prevent damage to the separator 230 due to welding.

The resin layer 231 may face the first welding line 521 of the first current collector 500. Here, “facing” means that the resin layer 231 is formed to extend in the third direction (Z-axis) in FIGS. 4 and 5, and the direction in which the resin layer 231 is formed to extend in the third direction is the same as the longitudinal direction of the first welding line 521. Accordingly, the resin layer 231 can reduce or prevent damage to the separator 230 due to welding.

The resin layer 231 has a predetermined or desired length and a predetermined or desired width. A length of the resin layer 231 is defined in the third direction (Z-axis) in FIGS. 3 and 4, and a width of the resin layer 231 is defined in the first direction (X-axis) in FIGS. 3 and 4.

The length of the resin layer 231 may be larger than a length of the first welding line 521 and smaller than a length of the first current collector plate 520. Accordingly, it is possible to sufficiently reduce or prevent damage to the separator due to welding, and reduce or prevent an increase in the air permeability of the separator due to an unnecessary resin layer.

The width of the resin layer 231 may be smaller than a width or length of the first tab member 301 (e.g., the first tab 310) in the first direction. Accordingly, the resin layer 231 is formed only in a region of the uncoated portion of the first electrode, and is not formed in a region of the separator that is in contact with the active material layer, thereby reducing or preventing an increase in the air permeability of the separator.

In one example, the width of the resin layer 231 may range from about 10% to about 50%, for example, 20% to 30%, of the width or length of the first tab member 301 (e.g., the first tab 310). In the above range, it is possible to reduce or prevent damage to the separator due to welding and reduce or prevent an increase in the air permeability of the separator.

In one example, the width of the resin layer 231 may range from about 0.1 to about 20 μm, but is not limited thereto.

A distance between the first welding line 521 and the resin layer 231 may be the same as the length of the first tab member 301 (e.g., the first tab 310). Accordingly, the resin layer can rapidly reduce or prevent damage to the separator caused by the first welding line.

The resin layer 231 may be formed only at an end of the separator 230 in the first direction.

In one example, the separator may include a porous substrate and a resin layer formed only at an end of at least one surface of the porous substrate in the first direction. In another example, the separator may include a porous substrate, a coating layer formed on at least one surface of the porous substrate, and a resin layer formed only at an end of one surface of the coating layer in the first direction.

The resin layer 231 may extend in the third direction intersecting the first direction, and extend to a region including the first tab member 301 (e.g., the first tab 310). Accordingly, it is possible to reduce or prevent damage to the separator due to welding of the first tab member 301 (e.g., the first tab 310) and the first current collector plate 520.

The resin layer 231 includes a resin having a high melting point compared to each of the porous substrate and the coating layer of the separator.

The resin may include, for example, one or more of a polyimide-based resin, a polyamide-based resin, a polyamideimide-based resin, a polyurethane-based resin, and a polycarbonate-based resin. The polyimide-based resin may include a resin having a moiety of the following Chemical Formula 1. The polyamide-based resin may include a resin having a moiety of the following Chemical Formula 2. The resin may include a resin having both moieties of the following Chemical Formulas 1 and 2.

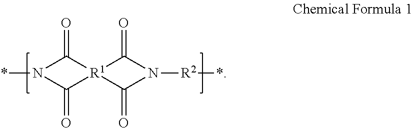

In Chemical Formula 1, * is a connecting portion of an element, R¹ is or includes a tetravalent organic group, and R² is or includes a divalent aliphatic, alicyclic, or aromatic organic group having a total number of carbon atoms of 3 to 30, or a combination thereof.

*-(—R¹—(C═O)—N(R₂)—)-* Chemical Formula 2:

In Chemical Formula 2, * is a connecting portion of an element, R¹ is or includes an alkylene group having 6 to 10 carbon atoms or an arylene group having 6 to 10 carbon atoms, and R² is hydrogen or an alkyl group having 6 to 10 carbon atoms or an aryl group having 6 to 10 carbon atoms.

For example, the resin may include a polyimide-based resin. The polyimide-based resin can reduce or prevent damage to the separator due to welding and have desired or improved durability when impregnated with an electrolyte.

For example, the polyimide-based resin may have a weight average molecular weight in a range of about 50,000 g/mol to about 2 million g/mol, for example, 10 g/mol to 1 million g/mol. In the above range, the polyimide-based resin readily forms a coating layer on the separator and has high heat resistance, and thus cannot be damaged by the heat generated due to welding.

The resin layer 231 may have a thickness in a range of about 0.1 μm to about 20 μm. In the above range, it is possible to reduce or prevent damage to the separator due to welding, and reduce or prevent an increase in the ion conductivity of the separator.

The resin layer 231 may have a uniform, or substantially uniform, thickness. Alternatively, the resin layer 231 may have a thickness that decreases away from the first current collector plate 520 in the first direction.

The resin layer 231 may not have a pattern including a resin but may have a predetermined or desired pattern. This may vary depending on the method of forming the resin layer 231.

The resin layer 231 may be formed by spraying the resin during the separator manufacturing process, but is not limited thereto.

The second current collector 600 may include a second terminal plate 610 and a second current collector plate 620.

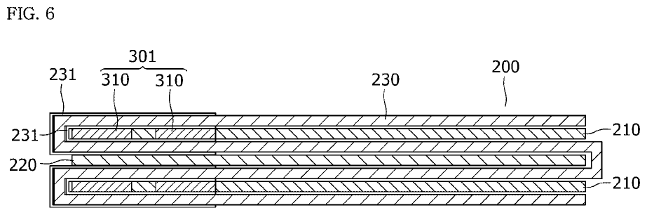

FIG. 6 is a cross-sectional view showing an electrode assembly included in a rechargeable battery according to another example embodiment of the present disclosure.

Referring to FIG. 6, the rechargeable battery includes an electrode assembly 200, and the electrode assembly 200 includes a separator 230 that is bent multiple times by alternately forming bent portions at one side and the other side in a zigzag or serpentine shape. The rechargeable battery is substantially the same as the rechargeable battery according to the above example embodiment, except that the rechargeable battery includes a first electrode 210 inserted into the one-side bent portion of the separator and having the first tab members 301 (e.g., the first tab 310), and a second electrode 220 inserted into the other-side bent portion of the separator.

The separator 230 includes one or more of a porous substrate and a coating layer, and a resin layer 231 having a higher melting point than each of the porous substrate and the coating layer.

The resin layer 231 may be formed on one or more of an inner side and outer side of the one-side bent portion. In one example, the resin layer may be formed on only the inner side of the one-side bent portion, formed on only the outer side of the one-side bent portion, or formed on both the inner side and the outer side of the one-side bent portion. For example, as shown in FIG. 6, the resin layer may be formed on both the inner side and the outer side of the one-side bent portion, thereby reducing or preventing damage to the separator due to welding.

The resin layer formed on the inner side of the one-side bent portion may be thinner than the resin layer formed on the outer side of the one-side bent portion. Accordingly, it is possible to reduce the force applied to the separator when the separator is bent in a zigzag or serpentine shape to form the one-side bent portion and the other-side bent portion.

The resin layer formed on the inner side of the one-side bent portion may include a resin having a lower weight average molecular weight than the resin layer formed on the outer side of the one-side bent portion. Accordingly, it is possible to reduce the force applied to the separator when the separator is bent in a zigzag or serpentine shape to form the one-side bent portion and the other-side bent portion. The weight average molecular weight may be obtained as a polystyrene-converted value by, e.g., gel permeation chromatography (GPC) but may not be limited thereto.

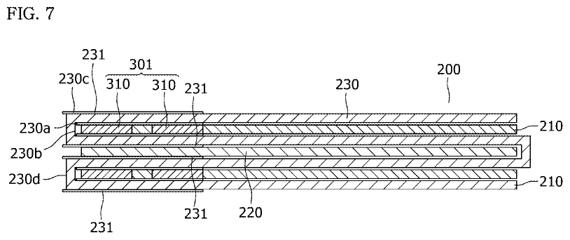

FIG. 7 is a cross-sectional view showing an electrode assembly included in a rechargeable battery according to still another example embodiment of the present disclosure.

Referring to FIG. 7, the rechargeable battery includes an electrode assembly 200, and the electrode assembly 200 includes a separator 230 that is bent multiple times by alternately forming bent portions at one side and the other side in a zigzag or serpentine shape. The rechargeable battery is substantially the same as the rechargeable battery according to the above-described example embodiment, except that the rechargeable battery includes a first electrode 210 inserted into the one-side bent portion of the separator 230 and having the first tab members 301 (e.g., the first tab 310), and a second electrode 220 inserted into the other-side bent portion of the separator 230.

The resin layer 231 may be formed on one or more of an inner side and an outer side of the one-side bent portion. In one example, the resin layer may be formed on only the inner side of the one-side bent portion, formed on only the outer side of the one-side bent portion, or formed on both the inner side and the outer side of the one-side bent portion. For example, the resin layer may be formed on both the inner side and the outer side of the one-side bent portion to reduce or prevent damage to the separator due to welding.

The one-side bent portion includes a pair of planar regions 230a facing the first current collector plate, and a bent connection region 230b connecting the pair of planar regions 230a. The resin layer 231 may be formed on only the planar region 230a, and may not be formed on the bent connection region 230b. Accordingly, it is possible to reduce the force applied to the separator when the separator is bent in a zigzag or serpentine shape to form the one-side bent portion and the other-side bent portion of the separator.

The other-side bent portion of the separator includes a pair of planar regions 230c facing the first current collector plate, and a bent connection region 230d connecting the pair of planar regions 230c. The resin layer 231 may be formed on only the planar region 230c, and may not be formed on the bent connection region 230d. Accordingly, it is possible to reduce the force applied to the separator when the separator is bent in a zigzag or serpentine shape to form the one-side bent portion and the other-side bent portion of the separator.

The case in which the resin layer 231 is formed for the first tab member 301 (e.g., the first tab 310) is described above, but the resin layer 231 may also be formed for the second tab member 302 (e.g., the second tab 320) in the same manner.

FIG. 8 is a schematic perspective view showing a configuration of a battery pack according to one example embodiment of the present disclosure.

The battery pack may include a housing 10, a rechargeable battery 1, and a busbar 3.

The housing 10 may form an approximate exterior of the battery pack and provide a space in which the rechargeable battery 1 may be accommodated.

The housing 10 according to the present example embodiment may include a housing body 11 and a cover 12.

The housing body 11 may have a box shape with an empty interior, and may have one open side. A cross-sectional shape of the housing body 11 is not limited to the rectangular, or substantially rectangular, shape shown in FIG. 8, and may be designed to have various shapes, such as, e.g., a polygon, circle, oval, and the like. The cover 12 may be fixed to the housing body 11 by various types of coupling methods, such as bolting, welding, fitting, and the like.

A plurality of rechargeable batteries 1 may be provided. The plurality of rechargeable batteries 1 may be arranged in two or more rows in at least one of a longitudinal direction (X-axis direction based on FIG. 8) and a width direction (Y-axis direction based on FIG. 8) of the housing 10. FIG. 8 shows an example in which the plurality of rechargeable batteries 1 are arranged in six rows in the longitudinal direction of the housing 10, but the arrangement form of the plurality of rechargeable batteries 1 is not limited thereto and may be designed to have various forms. The plurality of rechargeable batteries 1 may be disposed in parallel. The number of rechargeable batteries 1 may be designed in various ways according to the size, shape, and the like, of the housing 10.

The plurality of rechargeable batteries 1 may be electrically connected by the busbar 3. A plurality of busbars 3 may be supported inside the housing 10 by a busbar holder H.

According to one example embodiment, a rechargeable battery and a rechargeable battery pack are not damaged, or not substantially damaged, since a separator is not damaged when welded between a current collector and a tab member.

According to another example embodiment, a rechargeable battery and a rechargeable battery pack exhibit improved battery capacity due to a separator not being damaged even when a length of a tab member is short.

Although example embodiments of the present disclosure are described above, the present disclosure is not limited thereto and may be modified into various forms within the scope of the claims, the detailed description of the present disclosure, and the accompanying drawings, and the modifications also fall within the scope of the present disclosure.

What is claimed is:

1. A rechargeable battery comprising:
a case;
an electrode assembly disposed inside the case and having a first electrode, a separator, and a second electrode;
a cap assembly that seals the case and has a first terminal and a second terminal;
a first tab member extending from the electrode assembly in a first direction; and
a first current collector connected to the first terminal and the first tab member,
wherein the separator includes one or more of a porous substrate and a coating layer, and a resin layer having a higher melting point than each of the porous substrate and the coating layer, and
the resin layer faces the first current collector.

2. The rechargeable battery of claim 2, wherein the first current collector comprises a first current collector plate and a first terminal plate, and the resin layer faces the first current collector plate.

3. The rechargeable battery of claim 1, wherein the first current collector plate has a first welding line to which the first tab member is connected, and the resin layer faces the first welding line.

4. The rechargeable battery of claim 3, wherein a length of the resin layer is greater than a length of the first welding line and smaller than a length of the first current collector plate.

5. The rechargeable battery of claim 3, wherein a width of the resin layer is smaller than a width or length of the first tab member in the first direction.

6. The rechargeable battery of claim 3, wherein a distance between the first welding line and the resin layer is the same as a length of the first tab member.

7. The rechargeable battery of claim 3, wherein the resin layer is located at an end of the separator in the first direction and extends in a third direction intersecting the first direction.

8. The rechargeable battery of claim 3, further comprising a plurality of first tab members located in a third direction intersecting the first direction,
wherein the resin layer extends to a region including the plurality of first tab members in the third direction.

9. The rechargeable battery of claim 3, wherein the resin layer comprises one or more of a polyimide-based resin, a polyamide-based resin, a polyamideimide-based resin, a polyurethane-based resin, and a polycarbonate-based resin.

10. The rechargeable battery of claim 3, wherein the electrode assembly is formed by sequentially stacking the first electrode, the separator, and the second electrode.

11. The rechargeable battery of claim 3, wherein the electrode assembly comprises the separator that is bent multiple times by alternately forming bent portions at one side and the other side in a serpentine shape, the first electrode inserted into the bent portion of the separator at the one side and having the first tab member, and the second electrode inserted into the bent portion of the separator at the other side.

12. The rechargeable battery of claim 11, wherein the resin layer is formed on one or more of an inner side and an outer side of the bent portion at the one side.

13. The rechargeable battery of claim 12, wherein the resin layer formed on the inner side is thinner than the resin layer formed on the outer side.

14. The rechargeable battery of claim 12, wherein the resin layer formed on the inner side has a lower weight average molecular weight than the resin layer formed on the outer side.

15. A rechargeable battery pack comprising:
a housing; and
a plurality of rechargeable batteries disposed inside the housing,
wherein each of the rechargeable batteries comprises:
a case;
an electrode assembly disposed inside the case and having a first electrode, a separator, and a second electrode;
a cap assembly that seals the case and has a first terminal and a second terminal;
a first tab member extending from the electrode assembly in a first direction; and
a first current collector connected to the first terminal and the first tab member,
the separator includes one or more of a porous substrate and a coating layer,
the separator includes a resin layer having a higher melting point than each of the porous substrate and the coating layer, and
the resin layer faces the first current collector.
